(19) United States
(12) Patent Application Publication
(10) Pub. No.: US 2021/0049509 A1
(43) Pub. Date: Feb. 18, 2021

(54) BLOCKCHAIN-BASED METHOD AND APPARATUS FOR REWARDING WORK PERFORMER

(71) Applicant: Advanced New Technologies Co., Ltd., George Town (KY)

(72) Inventor: Xinying Yang, Hangzhou (CN)

(73) Assignee: Advanced New Technologies Co., Ltd., George Town (KY)

(21) Appl. No.: 17/084,183

(22) Filed: Oct. 29, 2020

Related U.S. Application Data
(63) Continuation of application No. PCT/CN2019/083079, filed on Apr. 17, 2019.

(30) Foreign Application Priority Data
Jul. 18, 2018 (CN) 201810793075.8

(51) Int. Cl. G06N 20/00; G06K 9/62; H04L 9/32

(52) U.S. Cl. CPC G06N 20/00; G06K 9/6262; H04L 2209/463; H04L 2209/603; H04L 2209/38; H04L 9/32

(57) ABSTRACT

Blockchain-based methods and apparatuses for rewarding a work performer are disclosed. In an embodiment, a method comprising: identifying a copyrightable work published by a blockchain node to a blockchain; obtaining a score that represents a performance quality of the copyrightable work; determining a virtual resource increment based on the score; generating a reward for the copyrightable work based on a node identifier of the blockchain node and the virtual resource increment; and broadcasting the reward to a blockchain network associated with the blockchain node comprising performing a consensus verification with blockchain nodes of the blockchain network to record, on the blockchain, 1) the reward, and 2) a mapping relationship between the node identifier and the virtual resource increment.

### CROSS-REFERENCE TO RELATED APPLICATIONS

This application is a continuation of PCT Application No. PCT/CN2019/083079, filed on Apr. 17, 2019, which claims priority to Chinese Patent Application No. 201810793075.8, filed on Jul. 18, 2018, and each application is hereby incorporated by reference in its entirety.

### TECHNICAL FIELD

Embodiments of the present specification relate to the field of information technologies, and in particular, to blockchain-based methods and apparatuses for rewarding a work performer.

### BACKGROUND

As the market pays increasing attention to copyright of works, a copyright service platform emerges. A work creator can register as a user with the copyright service platform, upload works to the copyright service platform, and execute copyright-related transactions with other users to obtain copyright benefits.

The copyright-related transaction refers to transaction activities carried out based on copyright works. For example, user A grants the copyright property rights (such as reproduction rights, issuance rights, adaptation rights, and performance rights) of a work created by user A to user B, and charges the royalty. For another example, user B uses a work created by user A (for example, appreciates the work or downloads the work), and pays user A for the use of the work.

In practice, to encourage users to upload performed works (for example, works adapted from existing works and works performed on existing works), the copyright service platform rewards users who upload performed works, for example, with cash. Specifically, when detecting that a user uploads a performed work, a server of the copyright service platform adds a certain amount to an account corresponding to a user identifier of the user as a reward.

Therefore, a more open and credible method for rewarding a work performer is needed.

### SUMMARY

To alleviate a problem that an existing method for rewarding a work performer is not open and credible enough, embodiments of the present specification provide blockchain-based methods and apparatuses for rewarding a work performer. The technical solutions are as follows:

According to a first aspect of the embodiments of the present specification, a blockchain-based method for rewarding a work performer is provided, where a blockchain network includes multiple service nodes, the service node has permission to publish a work in a blockchain, the multiple service nodes execute copyright-related transactions by using virtual resources as transaction media, and the method includes: obtaining a score used to represent performance quality of a performed work when it is detected that a target node publishes the performed work in the blockchain, where the score is positively correlated with the performance quality of the performed work, and the target node is any service node; determining a virtual resource increment based on the score; creating a performer reward transaction based on a node identifier of the target node and the determined virtual resource increment; and broadcasting the performer reward transaction to the blockchain network, so that a mapping relationship between the node identifier and the determined virtual resource increment is established and stored in the blockchain after consensus verification performed by multiple nodes in the blockchain network on the performer reward transaction succeeds.

According to a second aspect of the embodiments of the present specification, a blockchain-based apparatus for rewarding a work performer is provided, where a blockchain network includes multiple service nodes, the service node has permission to publish a work in a blockchain, the multiple service nodes execute copyright-related transactions by using virtual resources as transaction media, and the apparatus is a node in the blockchain network; and

The apparatus includes: an acquisition module, configured to obtain a score used to represent performance quality of a performed work when it is detected that a target node publishes the performed work in the blockchain, where the target node is any service node; a determining module, configured to determine a virtual resource increment based on the score; a creation module, configured to create a performer reward transaction based on a node identifier of the target node and the determined virtual resource increment; and a broadcasting module, configured to broadcast the performer reward transaction to the blockchain network, so that a mapping relationship between the node identifier and the determined virtual resource increment is established and stored in the blockchain after consensus verification performed by multiple nodes in the blockchain network on the performer reward transaction succeeds.

According to a third aspect of the embodiments of the present specification, a blockchain-based system for rewarding a work performer is provided, and includes a blockchain network that includes at least multiple service nodes, where the service node has permission to publish a work in a blockchain, and the multiple service nodes execute copyright-related transactions by using virtual resources as transaction media; and any node in the blockchain network is configured to obtain a score used to represent performance quality of a performed work when it is detected that a target node publishes the performed work in the blockchain, where the target node is any service node; determine a virtual resource increment based on the score; create a performer reward transaction based on a node identifier of the target node and the determined virtual resource increment; and broadcast the performer reward transaction to the blockchain network, so that a mapping relationship between the node identifier and the determined virtual resource increment is established and stored in the blockchain after consensus verification performed by multiple nodes in the blockchain network on the performer reward transaction succeeds

In the technical solutions of the embodiments of the present specification, the blockchain network includes the multiple service nodes, the service node has the permission to publish a work in the blockchain, and the multiple service nodes execute copyright-related transactions by using virtual resources as transaction media. A service node that publishes a performed work is rewarded by using a consensus mechanism in the blockchain network, so that virtual resources corresponding to the service node are increased. In addition, a virtual resource increment corresponding to the service node is determined based on performance quality of the performed work published by the service node. The multiple nodes in the blockchain network participate in, by using the consensus mechanism, the process of rewarding the service node that publishes the performed work, and the record of rewarding the service node is stored in the blockchain by the multiple nodes, and data stored in the blockchain is tamperproof. It can be seen that in the present embodiment of the present specification, the process of rewarding a work performer is open, and the record of rewarding a work performer is credible.

It should be understood that the previous general description and the following detailed description are merely illustrative and explanatory, and constitute no limitation on the present embodiments of the present specification.

In addition, any one of the embodiments of the present specification does not need to achieve all the effects described above.

### BRIEF DESCRIPTION OF DRAWINGS

To describe the technical solutions in the embodiments of the present specification or in the existing technology more clearly, the following briefly describes the accompanying drawings needed for describing the embodiments or the existing technology. Clearly, the accompanying drawings in the following description are merely some of the embodiments described in the embodiments of the present specification. A person of ordinary skill in the art can further derive other drawings from these accompanying drawings.

FIG. 1 is a schematic flowchart illustrating a blockchain-based method for rewarding a work performer, according to an embodiment of the present specification;

FIG. 2 is a schematic flowchart illustrating a method for training an adaptation quality evaluation model, according to an embodiment of the present specification;

FIG. 3 is a schematic flowchart illustrating an adaptation quality evaluation method, according to an embodiment of the present specification;

FIG. 4 is a schematic structural diagram of a blockchain-based method for rewarding a work performer, according to an embodiment of the present specification;

FIG. 5 is a schematic structural diagram of a blockchain-based system for rewarding a work performer, according to an embodiment of the present specification; and

FIG. 6 is a schematic structural diagram of a computer device for configuring a method in an embodiment of the present specification.

### DESCRIPTION OF EMBODIMENTS

Currently, in a copyright service application scenario, to encourage publication behavior of performed works, work performers are usually rewarded. However, an existing method for rewarding a work performer is mainly implemented by a server of a copyright service platform, and the entire rewarding process is not open and transparent enough. In addition, rewarding records corresponding to each work performer and stored on the server of the copyright service platform can be tampered with, and the copyright service platform sometimes fails to timely pay the work performer. That is, this method for rewarding a work performer is not highly credible, and does not achieve good effects for encouraging a work performer.

To alleviate this problem, the present specification first provides a blockchain-based copyright transaction method, and then provides a method for rewarding a work performer based on the copyright transaction method.

Specifically, in the blockchain-based copyright transaction method, a blockchain network includes multiple service nodes, the service node has permission to publish a work in a blockchain, and the multiple service nodes execute copyright-related transactions by using virtual resources as transaction media.

Further, the blockchain network further includes a management node, and the multiple service nodes execute copyright-related transactions by using virtual resources provided by the management node as transaction media. A virtual resource corresponding to each service node can be converted into property by the management node.

A typical copyright-related transaction can be described as follows:

For a copyright transaction event corresponding to a target work, a payer node determines a payment amount, where the payer node is a service node corresponding to a user who uses or purchases the target work; the payer node determines virtual resources of the payment amount as a virtual resource decrement corresponding to the payer node, and determines the virtual resources of the payment amount as a virtual resource increment corresponding to a publisher node, where the publisher node is a service node corresponding to a user who publishes the target work; and the payer node creates a payment transaction that includes the determined virtual resource decrement corresponding to the payer node and the virtual resource increment corresponding to the publisher node, and publishes the payment transaction in the blockchain.

The virtual resource is actually electronic data, and a specific form of the virtual resource can be a game coin, a bonus point, a virtual article, etc. For ease of description, in the following example, the work is specifically a music work, the virtual resource is specifically a “musical tone coin”, and a virtual resource of one amount is one musical tone coin. The name of musical tone coin TON is originally taken from tone, and ton itself has a weight meaning, and symbolizes value and density, and therefore the name is determined.

The payment amount is specifically the amount of virtual resources needed to use or purchase the target work, and can be predetermined by a publisher of the target work.

That is, in the previously described copyright transaction method, that the payment transaction is published in the blockchain means that a buyer or a user of the work pays a virtual resource to the publisher of the work, and the virtual resource payment record is stored in the blockchain for publicity.

In the previously described copyright transaction method, a service node may serve as a payer that pays a virtual resource in some copyright transaction events, or may serve as a publisher that collects a virtual resource in some copyright transaction events, a virtual resource payment record corresponding to each copyright transaction event is stored in a blockchain for publicity, and virtual resource inventory corresponding to each service node can be determined based on virtual resource payment records stored in the blockchain.

It is worthwhile to note that a transaction (transfer) described in the present specification can be a common property exchange activity such as a copyright-related transaction (purchase of copyright works, use of copyright works, etc.). In addition, in terms of a blockchain, a transaction can refer to a piece of data created by a user by using a client terminal of the blockchain and needing to be eventually published in a distributed database of the blockchain.

Transactions in the blockchain are classified into a transaction in a narrow sense and a transaction in a broad sense. The transaction in a narrow sense refers to a value transfer published by a user in the blockchain. For example, in a conventional bitcoin blockchain network, a transaction can be a transfer initiated by a user in a blockchain. The transaction in a broad sense refers to service data with a service intention published by a user in the blockchain. For example, an operator can build a consortium blockchain based on an actual service need, and deploy some other types of online services (for example, rental services, vehicle scheduling services, insurance claims services, credit services, and medical services) that are irrelevant to value transfer based on the consortium blockchain. In this type of consortium blockchain, a transaction can be a service message or a service request with a service intention published by a user in the consortium blockchain.

In the present specification, “transactions” other than copyright-related transactions and copyright transactions are usually transactions in a blockchain.

Based on the previous blockchain-based copyright transaction method, the present specification provides a method for rewarding a work performer. A service node that publishes a performed work is rewarded by using a consensus mechanism in a blockchain network, so that virtual resources corresponding to the service node are increased. In addition, a virtual resource increment corresponding to the service node is determined based on performance quality of the performed work published by the service node. Multiple nodes in the blockchain network participate in, by using the consensus mechanism, the process of rewarding the service node that publishes the performed work, and the record of rewarding the service node is stored in a blockchain by the multiple nodes, and data stored in the blockchain is tamperproof. It can be seen that in the embodiments of the present specification, the process of rewarding a work performer is open, and the record of rewarding a work performer is credible.

To make a person skilled in the art better understand the technical solutions in the embodiments of the present specification, the following describes the technical solutions in the embodiments of the present specification in detail with reference to the accompanying drawings in the embodiments of the present specification. Clearly, the described embodiments are merely some but not all of the embodiments of the present specification. All other embodiments obtained by a person of ordinary skill in the art based on the embodiments of the present specification shall fall within the protection scope.

The technical solutions provided in the embodiments of the present specification are described below in detail with reference to the accompanying drawings.

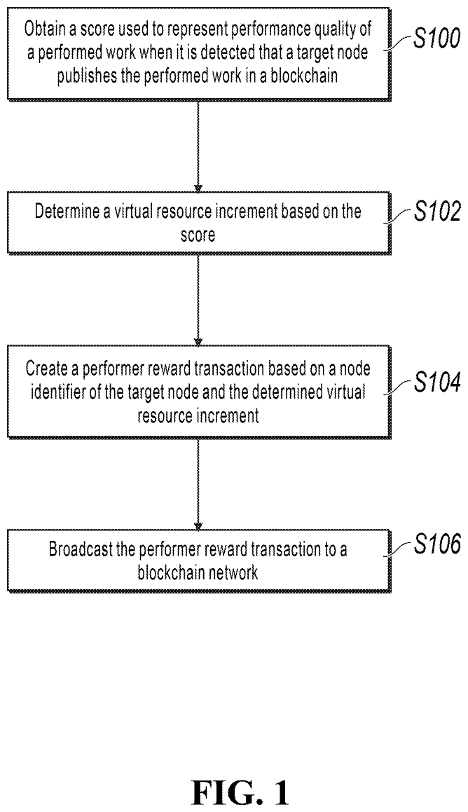

FIG. 1 is a schematic flowchart illustrating a blockchain-based method for rewarding a work performer, according to an embodiment of the present specification. The method includes the following steps.

S100. Obtain a score used to represent performance quality of a performed work when it is detected that a target node publishes the performed work in a blockchain.

S102. Determine a virtual resource increment based on the score.

In the present embodiment of the present specification, a blockchain network includes multiple service nodes, the service node has permission to publish a work in the blockchain, and the multiple service nodes execute copyright-related transactions by using virtual resources as transaction media.

In addition, it is worthwhile to note that a virtual resource payment record and a virtual resource collection record of each service node are stored in the blockchain. The virtual resource payment record corresponding to each service node is recorded in a form in which a node identifier of the service node corresponds to a specific virtual resource decrement. For example, “node A: −20” indicates that node A pays 20 musical tone coins. The virtual resource collection record corresponding to the service node is recorded in a form in which the node identifier of the service node corresponds to a specific virtual resource increment. For example, “node A: 20” indicates that node A collects 20 musical tone coins.

In addition, virtual resource inventory corresponding to each service node can be obtained by combining the virtual resource increment and the virtual resource decrement corresponding to the service node through by tracing the blockchain. for example, there are three virtual resource payment records of node A stored in the blockchain, and corresponding virtual resource decrements are −20, −50, and −60 respectively, and there are three virtual resource collection records of node A stored in the blockchain, and corresponding virtual resource increments are 50, 63, and 80 respectively. Therefore, current virtual resource inventory corresponding to node A is −20−50−60+50+63+80=63 musical tone coins.

The method can be performed by any service node (referred to as an execution node) in the blockchain network, and the execution node performs the method shown in FIG. 1 by invoking a smart contract stored in the blockchain and used for implementing the procedure of the method shown in FIG. 1. It is worthwhile to note that the execution node can be randomly designated from the service nodes whenever the method shown in FIG. 1 needs to be performed.

It is worthwhile to further note that because the target node is also any service node in the blockchain network, the target node and the execution node may be the same service node.

In addition, a management node can be added to the blockchain network as the execution node. The management node does not participate in copyright-related transactions, and is only responsible for managing the copyright-related transactions. The management node also performs the method shown in FIG. 1 by invoking the smart contract stored in the blockchain and used for implementing the procedure of the method shown in FIG. 1.

In addition, the management node is usually a provider of a transaction medium (namely, a virtual resource) used in a copyright-related transaction, and any service node requests the management node to convert a virtual resource owned by the any service node into property. For example, virtual resource inventory of a service node A is 20 musical tone coins. Assume that a manager corresponding to the management node specifies that one musical tone coin can be converted into 10 RMB. In this case, the service node A can request the management node to convert the 20 musical tone coins owned by the service node A into 200 RMB.

In the present embodiment of the present specification, the target node is any service node in the blockchain network. When detecting that the target node publishes the performed work in the blockchain, the execution node can start to perform the process of rewarding the target node. First, the score used to represent the performance quality of the performed work needs to be obtained. Then, a virtual resource to be provided to the target node, namely, the virtual resource increment corresponding to the target node, is determined based on the score.

It is worthwhile to note that if the performed work is a music work, the performed work usually can be a music adaptation work, a music performance work, or a music adaptation and performance work. Correspondingly, a score corresponding to the music adaptation work is used to represent adaptation quality of the music adaptation work, a score corresponding to the music performance work is used to represent performance quality of the music performance work, and a score corresponding to the music adaptation and performance work is used to comprehensively represent adaptation quality and performance quality of the music adaptation and performance work.

Further, music performance works can be divided into a music playing work and a music singing work. The musical playing work is mainly for absolute music, and the musical singing work is mainly for a song with lyrics. Correspondingly, a score corresponding to the musical playing work is used to represent playing quality of the musical playing work, and a score corresponding to the musical singing work is used to represent singing quality of the musical singing work.

In the present embodiment of the present specification, the score used to represent the performance quality of the performed work can be obtained by analyzing the performance quality of the performed work based on a predetermined evaluation rule; or the score used to represent the performance quality of the performed work can be obtained by analyzing the performance quality of the performed work based on a pre-trained evaluation model; or the score specified by a performed work evaluator and used to represent the performance quality of the performed work can be obtained.

It is worthwhile to note that the score is usually positively correlated with the performance quality of the performed work. When the virtual resource increment is determined based on the score, the virtual resource increment is usually positively correlated with the score.

For example, it can be predetermined that an upper limit of a virtual resource increment to be rewarded to a work performer is five musical tone coins. Assume that the score is 90 points (in a hundred-mark system). In this case, the virtual resource increment can be 5*90%100=4.5 musical tone coins.

Further, if the score is greater than a first score, virtual resources of a first specified amount are determined as the virtual resource increment; or if the score is less than a second score, virtual resources of a second specified amount are determined as the virtual resource increment, where the second score is less than a first score, and the second specified amount is less than a first specified amount; or if the score is neither greater than a first score nor less than a second score, it is determined that the virtual resource increment is positively correlated with the score, and the virtual resource increment is less than virtual resources of a first specified amount and is greater than virtual resources of a second specified amount.

For example, assume that the performance quality of the performed work is scored by using the hundred-mark system. In this case, the first score can be set to 80 points, and the second score can be set to 20 points. If the score is greater than 80 points, it indicates that the performance quality of the performed work is relatively high, and virtual resources of a relatively large amount (the first specified amount) can be determined as the virtual resource increment. If the score is less than 20 points, it indicates that the performance quality of the performed work is relatively low, and virtual resources of a relatively small amount (the second specified amount) can be determined as the virtual resource increment. If the score is between 20 points and 80 points, a higher score indicates a larger virtual resource increment.

S104. Create a performer reward transaction based on a node identifier of the target node and the determined virtual resource increment.

S106. Broadcast the performer reward transaction to the blockchain network.

After the virtual resource increment is determined, the virtual resource increment can be published in the blockchain. Specifically, as described above, a virtual resource collection record corresponding to any service node is recorded in a form in which a node identifier of the service node corresponds to a specific virtual resource increment. Therefore, the performer reward transaction can be created based on the node identifier of the target node and the virtual resource increment, and then the performer reward transaction is broadcast to the blockchain network, so that a mapping relationship between the node identifier and the determined virtual resource increment is established and stored in the blockchain after consensus verification performed by multiple nodes in the blockchain network on the performer reward transaction succeeds.

In addition, it is worthwhile to note that the multiple nodes are nodes that participate in consensus verification. The multiple nodes can be multiple service nodes. If the blockchain network includes not only the service nodes but also other nodes such as the management node, the multiple nodes can be nodes other than the service nodes.

Consensus verification on the performer reward transaction mainly means that the multiple nodes separately perform validity verification on the performer reward transaction, and reach a consensus on a validity verification result. Content of validity verification includes at least verifying whether a signature of the execution node that broadcasts the performer reward transaction is valid, whether the performer reward transaction is tampered with in the broadcasting process, etc.

In the method for rewarding a work performer shown in FIG. 1, a service node that publishes a performed work is rewarded by using a consensus mechanism in the blockchain network, so that virtual resources corresponding to the service node are increased. In addition, a virtual resource increment corresponding to the service node is determined based on performance quality of the performed work published by the service node. Multiple nodes in the blockchain network participate in, by using the consensus mechanism, the process of rewarding the service node that publishes the performed work, and the record of rewarding the service node is stored in the blockchain by the multiple nodes, and data stored in the blockchain is tamperproof. It can be seen that in the present embodiment of the present specification, the process of rewarding a work performer is open, and the record of rewarding a work performer is credible.

In addition, when the performed work is a music adaptation and performance work, in step S100, a first score used to represent adaptation quality of the music adaptation and performance work can be obtained, and a second score used to represent performance quality of the music adaptation and performance work can be obtained. In step S102, a first virtual resource sub-increment can be determined based on the first score, and a second virtual resource sub-increment can be determined based on the second score; and the first virtual resource sub-increment and the second virtual resource sub-increment can be combined into the virtual resource increment.

In addition, in the present embodiment of the present specification, a work type corresponding to the performed work can be determined as a target work type; a resource amount corresponding to the target work type can be determined as a target resource amount based on a predetermined mapping relationship between a work type and a resource amount; virtual resources of the target resource amount can be determined as an additional virtual resource increment; an additional performer reward transaction can be created based on the node identifier of the target node and the determined additional virtual resource increment; and the additional performer reward transaction can be broadcast to the blockchain network, so that a mapping relationship between the node identifier and the determined additional virtual resource increment is established and stored in the blockchain after consensus verification performed by the multiple nodes in the blockchain network on the additional performer reward transaction succeeds.

For example, assume that the work is a music work, the predetermined work types are jazz music, folk music, and rock music, a resource amount corresponding to the jazz music is 5, a resource amount corresponding to the folk music is 8, and a resource amount corresponding to the rock music is 3. In this case, if the work type of the performed work is the jazz music, five musical tone coins are determined as the additional virtual resource increment.

It is worthwhile to note that a resource amount corresponding to each work type can be adjusted based on an actual service need. Specifically, a resource amount adjustment module can be received; and a resource amount corresponding to at least one work type can be adjusted based on the resource amount adjustment instruction.

More specifically, if the mapping relationship between a work type and a resource amount is predetermined by using a smart contract, when the resource amount corresponding to the at least one work type is adjusted, a new smart contract is regenerated based on an adjusted mapping relationship between a work type and a resource amount and is published in the blockchain.

In addition, a work type corresponding to the performed work can be determined as a target work type; a coefficient corresponding to the target work type can be determined as a target coefficient based on a predetermined mapping relationship between a work type and a coefficient; the virtual resource increment can be multiplied by the target coefficient to obtain an additional virtual resource increment; an additional performer reward transaction can be created based on the node identifier of the target node and the determined additional virtual resource increment; and the additional performer reward transaction can be broadcast to the blockchain network, so that a mapping relationship between the node identifier and the determined additional virtual resource increment is established and stored in the blockchain after consensus verification performed by the multiple nodes in the blockchain network on the additional performer reward transaction succeeds.

For example, assume that the work is a music work, the predetermined work types are jazz music, folk music, and rock music, a coefficient corresponding to the jazz music is 0.5, a coefficient corresponding to the folk music is 0.8, and a coefficient corresponding to the rock music is 0.3. In addition, the virtual resource increment is 4.5 musical tone coins. In this case, if the work type of the performed work is the jazz music, 4.5*0.5=2.25 musical tone coins are determined as the additional virtual resource increment.

It is worthwhile to note that a coefficient corresponding to each work type can be adjusted based on an actual service need. Specifically, a coefficient adjustment instruction can be received; and a coefficient corresponding to at least one work type can be adjusted based on the coefficient adjustment instruction.

More specifically, if the mapping relationship between a work type and a coefficient is predetermined by using a smart contract, when the coefficient corresponding to the at least one work type is adjusted, a new smart contract is regenerated based on an adjusted mapping relationship between a work type and a coefficient and is published in the blockchain.

In conclusion, assume that user A corresponding to the service node A obtains a performed work B by adapting and singing a rock work A, and publishes the performed work B in the blockchain. Then, it can be obtained that an adaptation score of the performed work B is 90 points, a corresponding virtual resource increment is 5*90%=4.5 musical tone coins, a singing score of the performed work B is 60 points, and a corresponding virtual resource increment is 5*60%=3 musical tone coins. In addition, the performed work belongs to rock music, and a corresponding additional virtual resource increment is (3+4.5)*0.3=2.25 musical tone coins. Finally, it can be obtained through summation that a total of 4.5+3+2.25=9.75 musical tone coins are rewarded to the service node A for the publication of the performed work B.

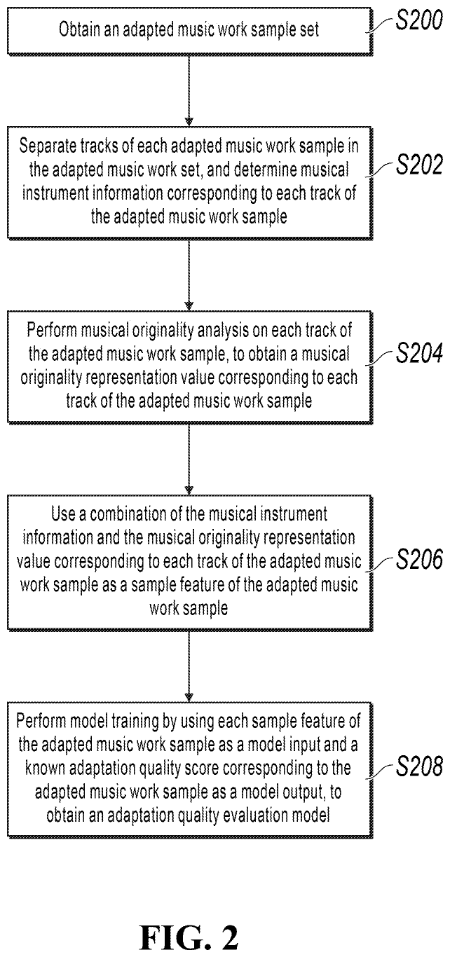

FIG. 2 is a schematic flowchart illustrating a method for training an adaptation quality evaluation model, according to an embodiment of the present specification. The method includes the following steps.

S200. Obtain an adapted music work sample set.

The method can be performed by a device with a data processing function such as a server, a computer, or a mobile phone.

In the present embodiment of the present specification, to make a trained adaptation quality evaluation model more accurate, a large number of adapted music works usually need to be obtained as samples to form an adapted music work sample set.

It is worthwhile to note that an adapted music work is usually a musical composition file in a digital format, for example, a composition file in a musical instrument digital interface (MIDI) format.

S202. Separate tracks of each adapted music work sample in the adapted music work set, and determine musical instrument information corresponding to each track of the adapted music work sample.

S204. Perform musical originality analysis on each track of the adapted music work sample, to obtain a musical originality representation value corresponding to each track of the adapted music work sample.

S206. Use a combination of the musical instrument information and the musical originality representation value corresponding to each track of the adapted music work sample as a sample feature of the adapted music work sample.

It is well known that in the field of model training, features of samples can be extracted, and model training is performed based on a sample feature of each sample and a label of the sample by using a supervised learning algorithm. The model training process is actually a process of learning, by a machine, a mapping relationship between a sample feature and a label of a sample. Therefore, after model training, a feature of a target object to be verified can be input to a model, and the model outputs a label of the target object.

In the present embodiment of the present specification, to obtain sample features of each adapted music work sample in the adapted music work set, steps S202 to S206 can be performed.

Usually, a melody corresponding to each track of a composition file is played by one or more musical instruments, and tracks correspond to different musical instruments. In the present embodiment of the present specification, if each adapted music work sample in the adapted music work set is a composition file in the MIDI format, because a melody of a composition file in the MIDI format is compiled for each track and the adapted music work sample also includes the musical instrument information corresponding to each track, it is easy to separate the tracks of the adapted music work sample, and the musical instrument information corresponding to each track of the adapted music work sample is obtained. It is worthwhile to note that the musical instrument information is usually a predetermined musical instrument number. For example, a musical instrument number of a guitar is 1, and a musical instrument number of a bass guitar is 5. The musical instrument information can be alternatively other strings that can uniquely identify musical instruments.

In addition, if the adapted music work sample is a composition file in a digital format other than the MIDI format, the tracks of the adapted music work sample can be separated by using a common track separation technology, and then a musical instrument corresponding to each track of the adapted music work sample can be analyzed based on different timbres features of various musical instruments. It is worthwhile to note that in this case, a musical instrument number can be pre-allocated to each musical instrument. As such, when the musical instrument corresponding to each track of the adapted music work sample is analyzed, the musical instrument information corresponding to each track of the adapted music work sample is determined.

In the present embodiment of the present specification, musical originality analysis means to compare a target melody with a reference melody in an existing melody library based on the melody library through numerical analysis, determine a reference melody most similar to the target melody as a key reference melody from the melody library, and obtain a similarity between the target melody and the key reference melody. This is a technical method well known to a person skilled in the art.

The similarity is usually a value between 0 to 100%, and represents the similarity between the target melody and the key reference melody. For example, the similarity of 20% indicates that the target melody is 20% similar to the key reference melody. Clearly, a higher similarity indicates lower originality of the target melody.

In the present embodiment of the present specification, each track of each adapted music work sample in the adapted music work sample set corresponds to a melody. Therefore, musical originality analysis is performed on each track of the adapted music work sample to obtain the musical originality representation value corresponding to each track of the adapted music work sample. A musical originality representation value corresponding to any track can be a similarity between a melody corresponding to the track and a key reference melody in the melody library. In this case, a larger musical originality representation value indicates lower originality of the melody corresponding to the track. The musical originality representation value corresponding to the track can be (1−a similarity). In this case, a larger musical originality representation value indicates higher originality of the melody corresponding to the track.

In addition, the musical originality representation value corresponding to the track can be obtained by performing other processing on the similarity, provided that the musical originality representation value corresponding to the track can represent the originality of the melody corresponding to the track.

In the present embodiment of the present specification, any adapted music work sample in the adapted music work set is used as an example for description. A combination of musical instrument information and a musical originality representation value corresponding to each track of the adapted music work sample is used as a sample feature of the adapted music work sample.

For example, track separation is performed on an adapted music work sample, and three tracks A, B, and C are obtained through separation, and it is further determined that a musical instrument number corresponding to the track A is 1 (guitar), a musical instrument number corresponding to the track B is 5 (bass guitar), and a musical instrument number corresponding to the track C is 3 (drum set). In addition, musical originality analysis is performed on each track of the adapted music work sample, and a musical originality representation value 70 corresponding to the track A, a musical originality representation value 50 corresponding to the track B, and a musical originality representation value 30 corresponding to the track C are obtained. Then, based on step S206, combinations of the three musical instrument numbers and the musical originality representation values, namely, (1, 70), (5, 50), and (3, 30), can be used as three sample features of the adapted music work sample.

S208. Perform model training by using each sample feature of the adapted music work sample as a model input and a known adaptation quality score corresponding to the adapted music work sample as a model output, to obtain an adaptation quality evaluation model.

After the sample features of each adapted music work sample in the adapted music work set are obtained, the label of the adapted music work sample, namely, the adaptation quality score corresponding to the adapted music work sample, further needs to be obtained. The adaptation quality score corresponding to the adapted music work sample is usually manually specified. Specifically, some music experts can evaluate adaptation quality of the adapted music work sample based on subjective experience, and give the adaptation quality score of the adapted music work sample.

After the sample features and the adaptation quality score of each adapted music work sample in the adapted music work set are obtained, model training can be performed for each adapted music work sample by using each sample feature of the adapted music work sample as a model input and the adaptation quality score corresponding to the adapted music work sample as a model output. Finally, the adaptation quality evaluation model is obtained.

In addition, any adapted music work sample in the adapted music work sample set is used as an example. In step S202, the following cases may occur for a track of the adapted music work sample:

In case 1, a musical instrument corresponding to the track cannot be identified.

In case 2, the musical instrument corresponding to the track may be a rare musical instrument.

For case 1 and case 2, a specified number can be predetermined as a number of an unknown musical instrument, and is used to uniformly identify musical instruments that cannot be identified and rare musical instruments. As such, musical instrument information corresponding to a track may be a predetermined musical instrument number or the specified number.

For example, the specified number can be 99. When a musical instrument corresponding to a track A of the adapted music work sample cannot be identified, a musical instrument number corresponding to the track A is determined as 99. When an analyzed musical instrument corresponding to a track B of the adapted music work sample is rare, and falls outside several predetermined musical instruments, a musical instrument number corresponding to the track B is also determined as 99. When an analyzed musical instrument corresponding to a track C of the adapted music work sample is a drum set, and falls within the several predetermined musical instruments, a musical instrument number corresponding to the track C is determined as a number corresponding to the drum set, for example, 3.

In the present embodiment of the present specification, further, the sample features of the adapted music work sample can include not only the several combinations of the musical instrument information and the musical originality representation values, but also any one of the following features: the number of pieces of pre-specified musical instrument information and a coordination representation value of the adapted music work sample.

1. The number of pieces of pre-specified musical instrument information. Specifically, before model training, the number of pieces of pre-specified musical instrument information in the musical instrument information corresponding to each adapted music work sample is determined, and the determined number is used as a sample feature corresponding to the adapted music work sample.

2. The coordination representation value corresponding to the adapted music work sample. Specifically, before model training, coordination analysis is performed on each track of each adapted music work sample, to obtain the coordination representation value corresponding to the adapted music work sample, and the obtained coordination representation value is used as a sample feature corresponding to the adapted music work sample.

Coordination analysis on the tracks means to analyze whether rhythms of melodies corresponding to the tracks are in harmony with each other, and a harmony degree between the rhythms of the melodies respectively corresponding to the tracks of the adapted music work sample is represented by the coordination representation value corresponding to the adapted music work sample.

Any adapted music work sample in the adapted music work sample set is used as an example for description. Assume that the pre-specified musical instrument information is musical instrument information 1, musical instrument information 5, and musical instrument information 6. A musical instrument number corresponding to a track A of the adapted music work sample is 1 (guitar), a musical instrument number corresponding to a track B is 5 (bass guitar), and a musical instrument number corresponding to a track C is 99 (unknown musical instrument). It can be seen that there are two pieces of pre-specified musical instrument information (namely, number 1 and number 5) in the musical instrument information corresponding to the adapted music work sample. In addition, it is determined, through musical originality analysis, that a musical originality representation value corresponding to the track A is 20, a musical originality representation value corresponding to the track B is 60, and a musical originality representation value corresponding to the track C is 80, and it is determined, through coordination analysis, that a coordination representation value corresponding to the adapted music work sample is 59. Therefore, sample features of the adapted music work sample are (1, 20), (5, 60), (99, 80), 2, and 59.

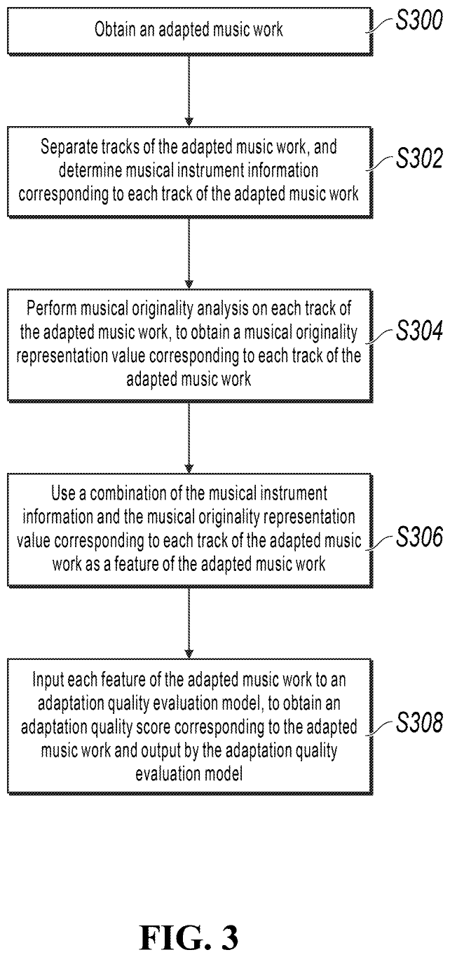

FIG. 3 is a schematic flowchart illustrating an adaptation quality evaluation method, according to an embodiment of the present specification. The method includes the following steps.

S300. Obtain an adapted music work.

S302. Separate tracks of the adapted music work, and determine musical instrument information corresponding to each track of the adapted music work.

S304. Perform musical originality analysis on each track of the adapted music work, to obtain a musical originality representation value corresponding to each track of the adapted music work.

S306: Use a combination of the musical instrument information and the musical originality representation value corresponding to each track of the adapted music work as a feature of the adapted music work.

S308. Input each feature of the adapted music work to an adaptation quality evaluation model, to obtain an adaptation quality score corresponding to the adapted music work and output by the adaptation quality evaluation model.

The adaptation quality evaluation method shown in FIG. 3 is actually a method for evaluating an adapted music work to be evaluated by using an adaptation quality evaluation model obtained by using the method for training an adaptation quality evaluation model shown in FIG. 2.

For the adapted music work to be evaluated, corresponding features of the adapted music work to be evaluated also need to be obtained, the features of the adapted music work to be evaluated are input to the adaptation quality evaluation model, and the adaptation quality evaluation model outputs an adaptation quality score corresponding to the adapted music work. A higher adaptation quality score usually indicates higher adaptation quality.

The musical instrument information corresponding to each track of the adapted music work is a number corresponding to a known musical instrument or a number corresponding to an unknown musical instrument.

Before each sample feature of the adapted music work is input to the adaptation quality evaluation model, the number of pieces of pre-specified musical instrument information in the musical instrument information corresponding to the adapted music work can be determined, and the determined number is used as a feature corresponding to the adapted music work.

Before each sample feature of the adapted music work is input to the adaptation quality evaluation model, coordination analysis can be performed on each track of the adapted music work to obtain a coordination representation value corresponding to the adapted music work, and the obtained coordination representation value is used as a feature corresponding to the adapted music work.

It is worthwhile to note that in the method shown in FIG. 3, a specific method for obtaining the features of the adapted music work to be evaluated is the same as the method for obtaining sample features of any adapted music work sample described in the description of the method shown in FIG. 2.

Adaptation quality of a large number of adapted music works can be efficiently evaluated by using the method for training an adaptation quality evaluation model shown in FIG. 2, the adaptation quality evaluation method shown in FIG. 3, and the trained adaptation quality evaluation model. In addition, model training is performed by using the musical instrument information and the musical originality representation value corresponding to each track of the adapted music work as features, so that the adaptation quality evaluation model can accurately evaluate the adaptation quality of the adapted music work.

It is worthwhile to note that in the method for rewarding a work performer shown in FIG. 1, when the performed work is a music adaptation work or a music adaptation and performance work, adaptation quality of the performed work can be evaluated by using the adaptation quality evaluation model obtained by using the method shown in FIG. 2 and the method shown in FIG. 3, to obtain a score used to represent the adaptation quality.

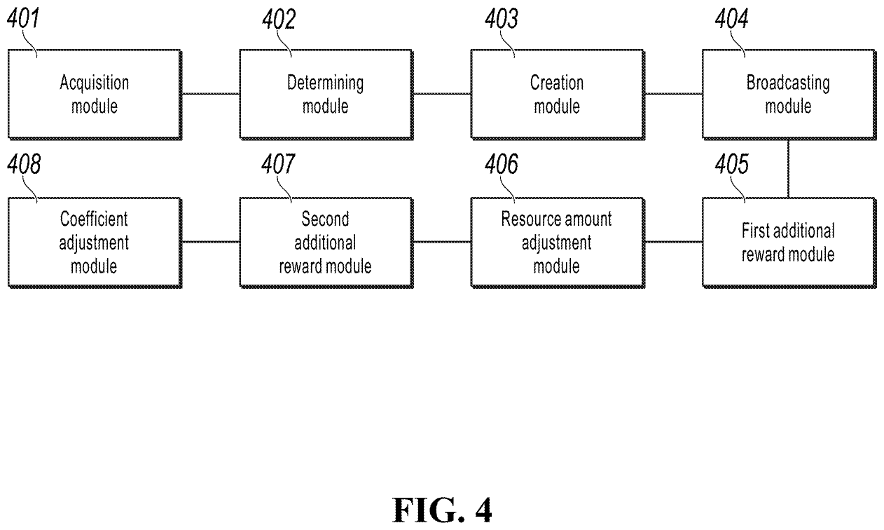

Based on the blockchain-based method for rewarding a work performer shown in FIG. 1, an embodiment of the present specification further correspondingly provides a blockchain-based apparatus for rewarding a work performer. As shown in FIG. 4, a blockchain network includes multiple service nodes, the service node has permission to publish a work in a blockchain, the multiple service nodes execute copyright-related transactions by using virtual resources as transaction media, and the apparatus is a node in the blockchain network.

The apparatus includes: an acquisition module 401, configured to obtain a score used to represent performance quality of a performed work when it is detected that a target node publishes the performed work in the blockchain, where the target node is any service node; a determining module 402, configured to determine a virtual resource increment based on the score; a creation module 403, configured to create a performer reward transaction based on a node identifier of the target node and the determined virtual resource increment; and a broadcasting module 404, configured to broadcast the performer reward transaction to the blockchain network, so that a mapping relationship between the node identifier and the determined virtual resource increment is established and stored in the blockchain after consensus verification performed by multiple nodes in the blockchain network on the performer reward transaction succeeds.

The acquisition module 401 is configured to obtain the score used to represent the performance quality of the performed work by analyzing the performance quality of the performed work based on a predetermined evaluation rule; or obtain the score used to represent the performance quality of the performed work by analyzing the performance quality of the performed work based on a pre-trained evaluation model; or obtain the score specified by a performed work evaluator and used to represent the performance quality of the performed work.

The score is positively correlated with the performance quality of the performed work, and the virtual resource increment is positively correlated with the score.

The determining module 402 is configured to determine virtual resources of a first specified amount as the virtual resource increment if the score is greater than a first score; or determine virtual resources of a second specified amount as the virtual resource increment if the score is less than a second score, where the second score is less than a first score, and the second specified amount is less than a first specified amount; or determine that the virtual resource increment is positively correlated with the score, and the virtual resource increment is less than virtual resources of a first specified amount and is greater than virtual resources of a second specified amount if the score is neither greater than a first score nor less than a second score.

The performed work specifically includes any one of a music adaptation work, a music performance work, and a music adaptation and performance work.

When the performed work is a music adaptation and performance work, the acquisition module 401 is configured to obtain a first score used to represent adaptation quality of the music adaptation and performance work, and obtain a second score used to represent performance quality of the music adaptation and performance work; and the determining module 402 is configured to determine a first virtual resource sub-increment based on the first score, and determine a second virtual resource sub-increment based on the second score; and combine the first virtual resource sub-increment and the second virtual resource sub-increment into the virtual resource increment.

The apparatus further includes a first additional reward module 405, configured to determine a work type corresponding to the performed work as a target work type; determine a resource amount corresponding to the target work type as a target resource amount based on a predetermined mapping relationship between a work type and a resource amount; determine virtual resources of the target resource amount as an additional virtual resource increment; create an additional performer reward transaction based on the node identifier of the target node and the determined additional virtual resource increment; and broadcast the additional performer reward transaction to the blockchain network, so that a mapping relationship between the node identifier and the determined additional virtual resource increment is established and stored in the blockchain after consensus verification performed by the multiple nodes in the blockchain network on the additional performer reward transaction succeeds.

The apparatus further includes a resource amount adjustment module 406, configured to receive a resource amount adjustment instruction; and adjust a resource amount corresponding to at least one work type based on the resource amount adjustment instruction.

The apparatus further includes a second additional reward module 407, configured to determine a work type corresponding to the performed work as a target work type; determine a coefficient corresponding to the target work type as a target coefficient based on a predetermined mapping relationship between a work type and a coefficient; multiply the virtual resource increment by the target coefficient to obtain an additional virtual resource increment; create an additional performer reward transaction based on the node identifier of the target node and the determined additional virtual resource increment; and broadcast the additional performer reward transaction to the blockchain network, so that a mapping relationship between the node identifier and the determined additional virtual resource increment is established and stored in the blockchain after consensus verification performed by the multiple nodes in the blockchain network on the additional performer reward transaction succeeds.

The apparatus further includes a coefficient adjustment module 408, configured to receive a coefficient adjustment instruction; and adjust a coefficient corresponding to at least one work type based on the coefficient adjustment instruction.

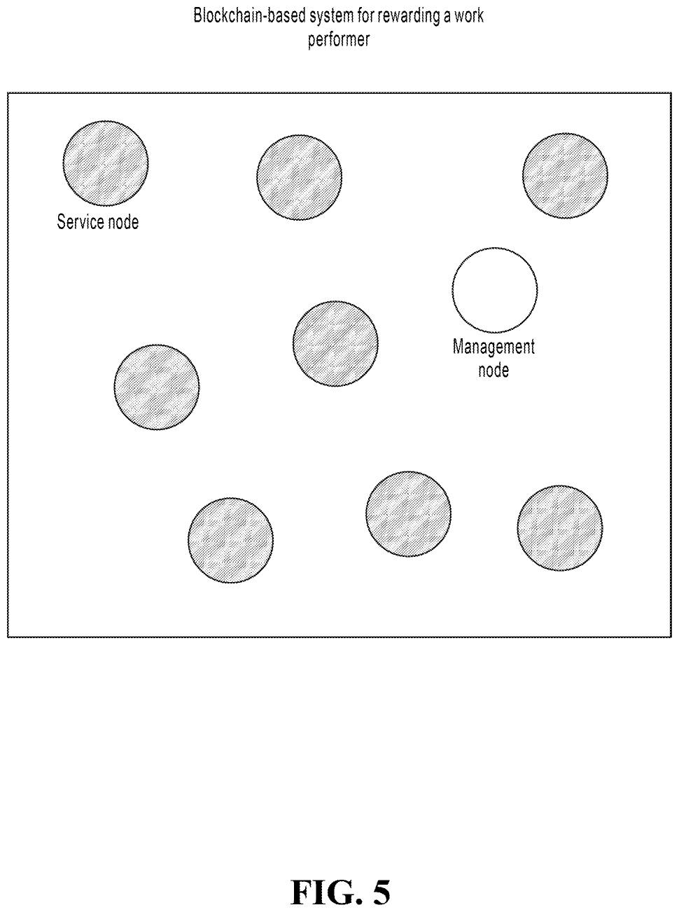

An embodiment of the present specification provides a blockchain-based system for rewarding a work performer. As shown in FIG. 5, the system includes a blockchain network that includes at least multiple service nodes, the service node has permission to publish a work in a blockchain, and the multiple service nodes execute copyright-related transactions by using virtual resources as transaction media.

Any node in the blockchain network is configured to obtain a score used to represent performance quality of a performed work when it is detected that a target node publishes the performed work in the blockchain, where the target node is any service node; determine a virtual resource increment based on the score; create a performer reward transaction based on a node identifier of the target node and the determined virtual resource increment; and broadcast the performer reward transaction to the blockchain network, so that a mapping relationship between the node identifier and the determined virtual resource increment is established and stored in the blockchain after consensus verification performed by multiple nodes in the blockchain network on the performer reward transaction succeeds

Further, the blockchain network includes a management node.

An embodiment of the present specification further provides a computer device. The device includes at least a memory, a processor, and a computer program stored in the memory and can run on the processor. When the processor executes the program, functions of the method shown in FIG. 1 are implemented.

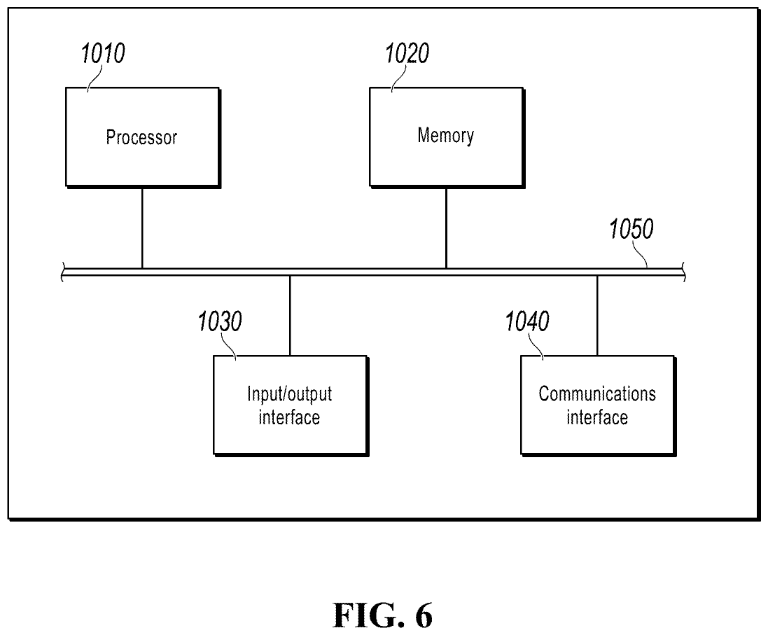

FIG. 6 is a schematic diagram of a more specific hardware structure of a computing device, according to an embodiment of the present specification. The device can include a processor 1010, a memory 1020, an input/output interface 1030, a communications interface 1040, and a bus 1050. The processor 1010, the memory 1020, the input/output interface 1030, and the communications interface 1040 implement communications connection with each other within the device by using the bus 1050.

The processor 1010 can be implemented by using a general-purpose central processing unit (CPU), a microprocessor, an application-specific integrated circuit (ASIC), one or more integrated circuits, etc., and is configured to execute a related program to implement the technical solutions provided in the embodiments of the present specification.

The memory 1020 can be implemented in a form of a read-only memory (ROM), a random access memory (RAM), a static storage device, a dynamic storage device, etc. The memory 1020 can store an operating system and other applications. When the technical solutions provided in the embodiments of the present specification are implemented by software or firmware, related program code is stored in the memory 1020 and is invoked and executed by the processor 1010.

The input/output interface 1030 is configured to connect an input/output module to input and output information. The input/output/module can be configured as a component (not shown in the figure) in the device or externally connected to the device to provide corresponding functions. Input devices can include a keyboard, a mouse, a touchscreen, a microphone, various sensors, etc. Output devices can include a display, a speaker, a vibrator, an indicator, etc.

The communications interface 1040 is configured to connect to a communications module (not shown in the figure) to implement communications interaction between the present device and other devices. The communications module can communicate in a wired way (such as a USB or a network cable) or a wireless way (such as a mobile network, WIFI, or Bluetooth).

The bus 1050 includes a channel for transmitting information between components (such as the processor 1010, the memory 1020, the input/output interface 1030, and the communications interface 1040) of the device.

It is worthwhile to note that although the device shows only the processor 1010, the memory 1020, the input/output interface 1030, the communications interface 1040, and the bus 1050, in a specific embodiment process, the device can further include other components necessary to implement normal operation. In addition, a person skilled in the art can appreciate that the device can include only components necessary to implement the embodiments of the present specification, and does not necessarily include all the components shown in the figure.

An embodiment of the present specification further provides a computer-readable storage medium. The computer-readable storage medium stores a computer program, and when the program is executed by a processor, functions of the method shown in FIG. 1 are implemented.

The computer-readable medium includes persistent, non-persistent, removable, and irremovable media that can store information by using any method or technology. The information can be a computer readable instruction, a data structure, a program module, or other data. Examples of a computer storage medium include but are not limited to a parameter random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or other optical storage, a cassette magnetic tape, magnetic tape/magnetic disk storage or another magnetic storage device, or any other non-transmission medium. The computer storage medium can be used to store information accessible by a computing device. Based on the definition in the present specification, the computer-readable medium does not include transitory computer readable media (transitory media) such as a modulated data signal and carrier.

It can be seen from the previous description of the embodiments that a person skilled in the art can clearly understand that the embodiments of the present specification can be implemented by software in addition to a necessary universal hardware platform. Based on such an understanding, the technical solutions of the embodiments of the present specification, essentially or the part contributing to the existing technology, can be embodied in a form of a software product. The software program product can be stored in a storage medium such as a ROM/RAM, a hard disk, or a compact disc, and includes several instructions for instructing a computer device (which can be a personal computer, a server, or a network device) to execute the methods described in the embodiments or some of the embodiments of the present specification.

The system, method, module, or unit illustrated in the previously described embodiments can be specifically implemented by a computer chip or an entity, or can be implemented by a product having a certain function. A typical embodiment device is a computer. Specific forms of the computer can be a personal computer, a laptop computer, a cellular phone, a camera phone, a smartphone, a personal digital assistant, a media player, a navigation device, an e-mail transceiver, a game console, a tablet computer, a wearable device, or any combination of several of these devices.

The embodiments of the present specification are described in a progressive way. For same or similar parts in the embodiments, references can be made to these embodiments, and each embodiment focuses on a difference from other embodiments. In particular, the apparatus embodiment and the device embodiment are basically similar to the method embodiment, and therefore are described briefly. For related parts, references can be made to partial description in the method embodiment. The described method embodiment is merely an example. The modules described as separate parts can be or does not have to be physically separate. The functions of the modules can be implemented in same or different software or hardware when implementing the solutions of the embodiments of the present specification. Some or all of the modules can be selected based on actual needs to achieve the objectives of the embodiments. A person of ordinary skill in the art can understand and implement the present specification without creative efforts.

The previous description is merely specific embodiments of the embodiments of the present specification. It is worthwhile to note that a person of ordinary skill in the art can make some improvements and modifications without departing from the principle of the embodiments of the present specification. These improvements and modifications shall also fall within the protection scope of the embodiments of the present specification.

What is claimed is:

1. A blockchain-based rewarding method comprising:
identifying a copyrightable work published by a blockchain node to a blockchain;
obtaining a score that represents a performance quality of the copyrightable work;
determining a virtual resource increment based on the score;
generating a reward for the copyrightable work based on a node identifier of the blockchain node and the virtual resource increment; and
broadcasting the reward to a blockchain network associated with the blockchain node comprising performing a consensus verification with blockchain nodes of the blockchain network to record, on the blockchain, 1) the reward, and 2) a mapping relationship between the node identifier and the virtual resource increment.

2. The method according to claim 1, wherein the score is obtained based on a pre-trained performance evaluation machine-learning model.

3. The method according to claim 1, wherein the score is positively correlated with the performance quality of the copyrightable work, and the virtual resource increment is positively correlated with the score.

4. The method according to claim 1, wherein the determining the virtual resource increment based on the score comprises:
determining virtual resources of a first amount as the virtual resource increment if the score is greater than a first score;
determining virtual resources of a second amount as the virtual resource increment if the score is less than a second score, wherein the second score is less than a first score, and the second amount is less than a first amount; and
determining that the virtual resource increment is positively correlated with the score, and the virtual resource increment is less than virtual resources of the first amount and is greater than virtual resources of the second amount if the score is greater than or equal to the second score and is less than or equal to the first score.

5. The method according to claim 1, wherein the copyrightable work is one of a music adaptation work, a music performance work, and a music adaptation and performance work.

6. The method according to claim 5, wherein the copyrightable work is the music adaptation and performance work, the score is obtained based on a first score that represents a music adaptation quality and a second score that represents a music performance quality, the virtual resource increment is determined based on combining a first virtual resource increment determined based on the first score and a second virtual resource increment determined based on the second score.

7. The method according to claim 1, further comprising:
determining a music work type of the copyrightable work;
determining a resource amount corresponding to the music work type as a target resource amount based on a predetermined mapping relationship between a music work type and a resource amount;
determining virtual resources of the target resource amount as an additional virtual resource increment;
generating an additional reward for the copyrightable work based on the node identifier of the blockchain node and the additional virtual resource increment;
broadcasting the additional reward to the blockchain network; and
performing a consensus algorithm to record the additional reward, and a mapping relationship between the node identifier and the additional virtual resource increment on the blockchain.

8. The method according to claim 7, further comprising:
receiving a resource amount adjustment instruction; and
adjusting the resource amount corresponding to at least one music work type based on the resource amount adjustment instruction.

9. The method according to claim 1, further comprising:
determining a music work type of the copyrightable work;
determining a coefficient corresponding to the music work type as a target coefficient based on a predetermined mapping relationship between the music work type and the coefficient;
determining an additional virtual resource increment based on multiplying the virtual resource increment with the target coefficient;
generating an additional reward based on the node identifier of the blockchain node and the additional virtual resource increment;
broadcasting the additional reward to the blockchain network; and
performing a consensus algorithm to record the additional reward, and a mapping relationship between the node identifier and the additional virtual resource increment on the blockchain.

10. The method according to claim 9, further comprising:
receiving a coefficient adjustment instruction; and
adjusting the coefficient corresponding to at least one music work type based on the coefficient adjustment instruction.

11. A non-transitory, computer-readable medium storing one or more instructions executable by a computer system to perform operations comprising:
identifying a copyrightable work published by a blockchain node to a blockchain;
obtaining a score that represents a performance quality of the copyrightable work;
determining a virtual resource increment based on the score;
generating a reward for the copyrightable work based on a node identifier of the blockchain node and the virtual resource increment; and
broadcasting the reward to a blockchain network associated with the blockchain node comprising performing a consensus verification with blockchain nodes of the blockchain network to record, on the blockchain, 1) the reward, and 2) a mapping relationship between the node identifier and the virtual resource increment.

12. The non-transitory, computer-readable medium according to claim 11, wherein the score is obtained based on a pre-trained performance evaluation machine-learning model.

13. The non-transitory, computer-readable medium according to claim 11, wherein the score is positively correlated with the performance quality of the copyrightable work, and the virtual resource increment is positively correlated with the score.

14. The non-transitory, computer-readable medium according to claim 11, wherein the determining the virtual resource increment based on the score comprises:
determining virtual resources of a first amount as the virtual resource increment if the score is greater than a first score;
determining virtual resources of a second amount as the virtual resource increment if the score is less than a second score, wherein the second score is less than a first score, and the second amount is less than a first amount; and
determining that the virtual resource increment is positively correlated with the score, and the virtual resource increment is less than virtual resources of the first amount and is greater than virtual resources of the second amount if the score is greater than or equal to the second score and is less than or equal to the first score.

15. The non-transitory, computer-readable medium according to claim 11, wherein the copyrightable work is one of a music adaptation work, a music performance work, and a music adaptation and performance work.

16. The non-transitory, computer-readable medium according to claim 15, wherein the copyrightable work is the music adaptation and performance work, the score is obtained based on a first score that represents a music adaptation quality and a second score that represents a music performance quality, the virtual resource increment is determined based on combining a first virtual resource increment determined based on the first score and a second virtual resource increment determined based on the second score.

17. The non-transitory, computer-readable medium according to claim 11, the operations further comprising:
determining a music work type of the copyrightable work;
determining a resource amount corresponding to the music work type as a target resource amount based on a predetermined mapping relationship between a music work type and a resource amount;
determining virtual resources of the target resource amount as an additional virtual resource increment;
generating an additional reward for the copyrightable work based on the node identifier of the blockchain node and the additional virtual resource increment;
broadcasting the additional reward to the blockchain network; and
performing a consensus algorithm to record the additional reward, and a mapping relationship between the node identifier and the additional virtual resource increment on the blockchain.

18. The non-transitory, computer-readable medium according to claim 17, the operations further comprising:
receiving a resource amount adjustment instruction; and
adjusting the resource amount corresponding to at least one music work type based on the resource amount adjustment instruction.

19. The non-transitory, computer-readable medium according to claim 11, the operations further comprising:
determining a music work type of the copyrightable work;
determining a coefficient corresponding to the music work type as a target coefficient based on a predetermined mapping relationship between the music work type and the coefficient;
determining an additional virtual resource increment based on multiplying the virtual resource increment with the target coefficient;
generating an additional reward based on the node identifier of the blockchain node and the additional virtual resource increment;
broadcasting the additional reward to the blockchain network; and
performing a consensus algorithm to record the additional reward, and a mapping relationship between the node identifier and the additional virtual resource increment on the blockchain.

20. The non-transitory, computer-readable medium according to claim 19, the operations further comprising:
receiving a coefficient adjustment instruction; and
adjusting the coefficient corresponding to at least one music work type based on the coefficient adjustment instruction.

21. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying a copyrightable work published by a blockchain node to a blockchain;
obtaining a score that represents a performance quality of the copyrightable work;
determining a virtual resource increment based on the score;
generating a reward for the copyrightable work based on a node identifier of the blockchain node and the virtual resource increment; and
broadcasting the reward to a blockchain network associated with the blockchain node comprising
performing a consensus verification with blockchain nodes of the blockchain network to record, on the blockchain, 1) the reward, and 2) a mapping relationship between the node identifier and the virtual resource increment.

22. The computer-implemented system according to claim 21, wherein the score is obtained based on a pre-trained performance evaluation machine-learning model.

23. The computer-implemented system according to claim 21, wherein the score is positively correlated with the performance quality of the copyrightable work, and the virtual resource increment is positively correlated with the score.

24. The computer-implemented system according to claim 21, wherein the determining the virtual resource increment based on the score comprises:
determining virtual resources of a first amount as the virtual resource increment if the score is greater than a first score;
determining virtual resources of a second amount as the virtual resource increment if the score is less than a second score, wherein the second score is less than a first score, and the second amount is less than a first amount; and
determining that the virtual resource increment is positively correlated with the score, and the virtual resource increment is less than virtual resources of the first amount and is greater than virtual resources of the second amount if the score is greater than or equal to the second score and is less than or equal to the first score.

25. The computer-implemented system according to claim 21, wherein the copyrightable work is one of a music adaptation work, a music performance work, and a music adaptation and performance work.

26. The computer-implemented system according to claim 25, wherein the copyrightable work is the music adaptation and performance work, the score is obtained based on a first score that represents a music adaptation quality and a second score that represents a music performance quality, the virtual resource increment is determined based on combining a first virtual resource increment determined based on the first score and a second virtual resource increment determined based on the second score.

27. The computer-implemented system according to claim 21, the one or more operations further comprising:
determining a music work type of the copyrightable work;
determining a resource amount corresponding to the music work type as a target resource amount based on a predetermined mapping relationship between a music work type and a resource amount;
determining virtual resources of the target resource amount as an additional virtual resource increment;
generating an additional reward for the copyrightable work based on the node identifier of the blockchain node and the additional virtual resource increment;
broadcasting the additional reward to the blockchain network; and
performing the consensus algorithm to record the additional reward, and a mapping relationship between the node identifier and the additional virtual resource increment on the blockchain.

28. The computer-implemented system according to claim 27, the one or more operations further comprising:
receiving a resource amount adjustment instruction; and
adjusting the resource amount corresponding to at least one music work type based on the resource amount adjustment instruction.

29. The computer-implemented system according to claim 21, the one or more operations further comprising:
determining a music work type of the copyrightable work;
determining a coefficient corresponding to the music work type as a target coefficient based on a predetermined mapping relationship between the music work type and the coefficient;
determining an additional virtual resource increment based on multiplying the virtual resource increment with the target coefficient;
generating an additional reward based on the node identifier of the blockchain node and the additional virtual resource increment;
broadcasting the additional reward to the blockchain network; and
performing the consensus algorithm to record the additional reward, and a mapping relationship between the node identifier and the additional virtual resource increment on the blockchain.

30. The computer-implemented system according to claim 29, the one or more operations further comprising:
receiving a coefficient adjustment instruction; and
adjusting the coefficient corresponding to at least one music work type based on the coefficient adjustment instruction.
